(19) United States
(12) Patent Application Publication
(10) Pub. No.: US 2025/0110633 A1
(43) Pub. Date: Apr. 3, 2025

(54) TECHNIQUES FOR CONFIGURING NAVIGATION OF A DEVICE

(71) Applicant: Apple Inc., Cupertino, CA (US)

(72) Inventors: Moritz VON VOLKMANN, Sunnyvale, CA (US); Christopher P. FOSS, San Francisco, CA (US); Andrew S. KIM, Walnut Creek, CA (US); David A. KRIMSLEY, Sunnyvale, CA (US); Corey K. WANG, Palo Alto, CA (US)

(21) Appl. No.: 18/896,455

(22) Filed: Sep. 25, 2024

Related U.S. Application Data
(60) Provisional application No. 63/541,810, filed on Sep. 30, 2023.
(60) Provisional application No. 63/541,821, filed on Sep. 30, 2023.
(60) Provisional application No. 63/587,108, filed on Sep. 30, 2023.

(51) Int. Cl. G06F 3/04847

(52) U.S. Cl. CPC G06F 3/04847

(57) ABSTRACT

The present disclosure generally relates to configuring navigation of a device.

### CROSS-REFERENCE TO RELATED APPLICATIONS

This application claims priority to U.S. Provisional Patent Application Ser. No. 63/541,810 entitled “TECHNIQUES FOR CONFIGURING NAVIGATION OF A DEVICE,” filed Sep. 30, 2023, to U.S. Provisional Patent Application Ser. No. 63/541,821 entitled “USER INPUT FOR INTERACTING WITH DIFFERENT MAP DATA,” filed Sep. 30, 2023, and to U.S. Provisional Patent Application Ser. No. 63/587,108 entitled “TECHNIQUES AND USER INTERFACES FOR PROVIDING NAVIGATION ASSISTANCE,” filed Sep. 30, 2023, which are incorporated by reference herein in their entireties for all purposes.

### FIELD

The present disclosure relates generally to computer user interfaces, and more specifically to techniques for configuring navigation of a device.

### BACKGROUND

Electronic devices are often capable of navigating to destinations. Such destinations can be static (e.g., stationary and/or not dynamically configurable). Such destinations can also be broadly defined such that arrival at the destination is imprecise.

### SUMMARY

Some techniques for configuring navigation of a device using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for configuring navigation of a device. Such methods and interfaces optionally complement or replace other methods for configuring navigation of a device. Such methods and interfaces reduce the cognitive burden on a user and produce a more efficient human-machine interface. For battery-operated computing devices, such methods and interfaces conserve power and increase the time between battery charges, for example, by reducing the number of unnecessary, extraneous, and/or repetitive received inputs and reducing battery usage by a display.

In some embodiments, a method that is performed at a computer system that is in communication with a display component and one or more input devices is described. In some embodiments, the method comprises: displaying, via the display component, a first indication that a first device is navigating with respect to a second device different from the first device; while the first device is navigating with respect to the second device, receiving, via the one or more input devices, a request to have the first device navigate with respect to a third device instead of the second device, wherein the third device is different from the first device; in response to receiving the request, displaying, via the display component, a second indication that the first device is navigating with respect to the third device.

In some embodiments, a non-transitory computer-readable storage medium storing one or more programs configured to be executed by one or more processors of a computer system that is in communication with a display component and one or more input devices is described. In some embodiments, the one or more programs includes instructions for: displaying, via the display component, a first indication that a first device is navigating with respect to a second device different from the first device; while the first device is navigating with respect to the second device, receiving, via the one or more input devices, a request to have the first device navigate with respect to a third device instead of the second device, wherein the third device is different from the first device; in response to receiving the request, displaying, via the display component, a second indication that the first device is navigating with respect to the third device.

In some embodiments, a transitory computer-readable storage medium storing one or more programs configured to be executed by one or more processors of a computer system that is in communication with a display component and one or more input devices is described. In some embodiments, the one or more programs includes instructions for: displaying, via the display component, a first indication that a first device is navigating with respect to a second device different from the first device; while the first device is navigating with respect to the second device, receiving, via the one or more input devices, a request to have the first device navigate with respect to a third device instead of the second device, wherein the third device is different from the first device; in response to receiving the request, displaying, via the display component, a second indication that the first device is navigating with respect to the third device.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: displaying, via the display component, a first indication that a first device is navigating with respect to a second device different from the first device; while the first device is navigating with respect to the second device, receiving, via the one or more input devices, a request to have the first device navigate with respect to a third device instead of the second device, wherein the third device is different from the first device; in response to receiving the request, displaying, via the display component, a second indication that the first device is navigating with respect to the third device.

In some embodiments, a computer system that is in communication with a display component and one or more input devices is described. In some embodiments, the computer system that is in communication with a display component and one or more input devices comprises means for performing each of the following steps: displaying, via the display component, a first indication that a first device is navigating with respect to a second device different from the first device; while the first device is navigating with respect to the second device, receiving, via the one or more input devices, a request to have the first device navigate with respect to a third device instead of the second device, wherein the third device is different from the first device; in response to receiving the request, displaying, via the display component, a second indication that the first device is navigating with respect to the third device.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: displaying, via the display component, a first indication that a first device is navigating with respect to a second device different from the first device; while the first device is navigating with respect to the second device, receiving, via the one or more input devices, a request to have the first device navigate with respect to a third device instead of the second device, wherein the third device is different from the first device; in response to receiving the request, displaying, via the display component, a second indication that the first device is navigating with respect to the third device.

In some embodiments, a method that is performed at a computer system that is in communication with a display component and one or more input devices is described. In some embodiments, the method comprises: after capture of one or more images of a location, displaying, via the display component, a representation of a respective device at a first position within a representation of the location, wherein the representation of the location is generated based on the one or more images; receiving, via the one or more input devices, a set of one or more inputs, wherein the set of one or more inputs includes an input corresponding to a request to move the representation of the respective device from the first position to a second position within the representation of the location, and wherein the second position is different from the first position; and in response to receiving the set of one or more inputs and in accordance with a determination that a first set of criteria are met: displaying, via the display component, the representation of the respective device at the second position; and configuring the respective device in a first manner, such that the respective device is caused to be navigated to a specific location corresponding to the second position when the respective device is caused to be navigated to the location.

In some embodiments, a non-transitory computer-readable storage medium storing one or more programs configured to be executed by one or more processors of a computer system that is in communication with a display component and one or more input devices is described. In some embodiments, the one or more programs includes instructions for: after capture of one or more images of a location, displaying, via the display component, a representation of a respective device at a first position within a representation of the location, wherein the representation of the location is generated based on the one or more images; receiving, via the one or more input devices, a set of one or more inputs, wherein the set of one or more inputs includes an input corresponding to a request to move the representation of the respective device from the first position to a second position within the representation of the location, and wherein the second position is different from the first position; and in response to receiving the set of one or more inputs and in accordance with a determination that a first set of criteria are met: displaying, via the display component, the representation of the respective device at the second position; and configuring the respective device in a first manner, such that the respective device is caused to be navigated to a specific location corresponding to the second position when the respective device is caused to be navigated to the location.

In some embodiments, a transitory computer-readable storage medium storing one or more programs configured to be executed by one or more processors of a computer system that is in communication with a display component and one or more input devices is described. In some embodiments, the one or more programs includes instructions for: after capture of one or more images of a location, displaying, via the display component, a representation of a respective device at a first position within a representation of the location, wherein the representation of the location is generated based on the one or more images; receiving, via the one or more input devices, a set of one or more inputs, wherein the set of one or more inputs includes an input corresponding to a request to move the representation of the respective device from the first position to a second position within the representation of the location, and wherein the second position is different from the first position; and in response to receiving the set of one or more inputs and in accordance with a determination that a first set of criteria are met: displaying, via the display component, the representation of the respective device at the second position; and configuring the respective device in a first manner, such that the respective device is caused to be navigated to a specific location corresponding to the second position when the respective device is caused to be navigated to the location.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: after capture of one or more images of a location, displaying, via the display component, a representation of a respective device at a first position within a representation of the location, wherein the representation of the location is generated based on the one or more images; receiving, via the one or more input devices, a set of one or more inputs, wherein the set of one or more inputs includes an input corresponding to a request to move the representation of the respective device from the first position to a second position within the representation of the location, and wherein the second position is different from the first position; and in response to receiving the set of one or more inputs and in accordance with a determination that a first set of criteria are met: displaying, via the display component, the representation of the respective device at the second position; and configuring the respective device in a first manner, such that the respective device is caused to be navigated to a specific location corresponding to the second position when the respective device is caused to be navigated to the location.

In some embodiments, a computer system that is in communication with a display component and one or more input devices is described. In some embodiments, the computer system that is in communication with a display component and one or more input devices comprises means for performing each of the following steps: after capture of one or more images of a location, displaying, via the display component, a representation of a respective device at a first position within a representation of the location, wherein the representation of the location is generated based on the one or more images; receiving, via the one or more input devices, a set of one or more inputs, wherein the set of one or more inputs includes an input corresponding to a request to move the representation of the respective device from the first position to a second position within the representation of the location, and wherein the second position is different from the first position; and in response to receiving the set of one or more inputs and in accordance with a determination that a first set of criteria are met: displaying, via the display component, the representation of the respective device at the second position; and configuring the respective device in a first manner, such that the respective device is caused to be navigated to a specific location corresponding to the second position when the respective device is caused to be navigated to the location.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: after capture of one or more images of a location, displaying, via the display component, a representation of a respective device at a first position within a representation of the location, wherein the representation of the location is generated based on the one or more images; receiving, via the one or more input devices, a set of one or more inputs, wherein the set of one or more inputs includes an input corresponding to a request to move the representation of the respective device from the first position to a second position within the representation of the location, and wherein the second position is different from the first position; and in response to receiving the set of one or more inputs and in accordance with a determination that a first set of criteria are met: displaying, via the display component, the representation of the respective device at the second position; and configuring the respective device in a first manner, such that the respective device is caused to be navigated to a specific location corresponding to the second position when the respective device is caused to be navigated to the location.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for configuring navigation of a device, thereby increasing the effectiveness, efficiency, and user satisfaction with such devices. Such methods and interfaces may complement or replace other methods for configuring navigation of a device.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2D illustrate exemplary user interfaces for navigating a first device with respect to a second device in accordance with some embodiments.

FIG. 3 is a flow diagram illustrating methods for navigating a first device with respect to a second device in accordance with some embodiments.

FIGS. 4A-4G illustrate exemplary user interfaces for configuring a device to navigate to a specific location in accordance with some embodiments.

FIG. 5 is a flow diagram illustrating methods for configuring a device to navigate to a specific location in accordance with some embodiments.

### DETAILED DESCRIPTION

The following description sets forth exemplary techniques for configuring navigation of a device. This description is not intended to limit the scope of this disclosure but is instead provided as a description of example implementations.

Users need electronic devices that provide effective techniques for configuring navigation of a device. Efficient techniques can reduce a user's mental load when configuring navigation of a device. This reduction in mental load can enhance user productivity and make the device easier to use. In some embodiments, the techniques described herein can reduce battery usage and processing time (e.g., by providing user interfaces that require fewer user inputs to operate).

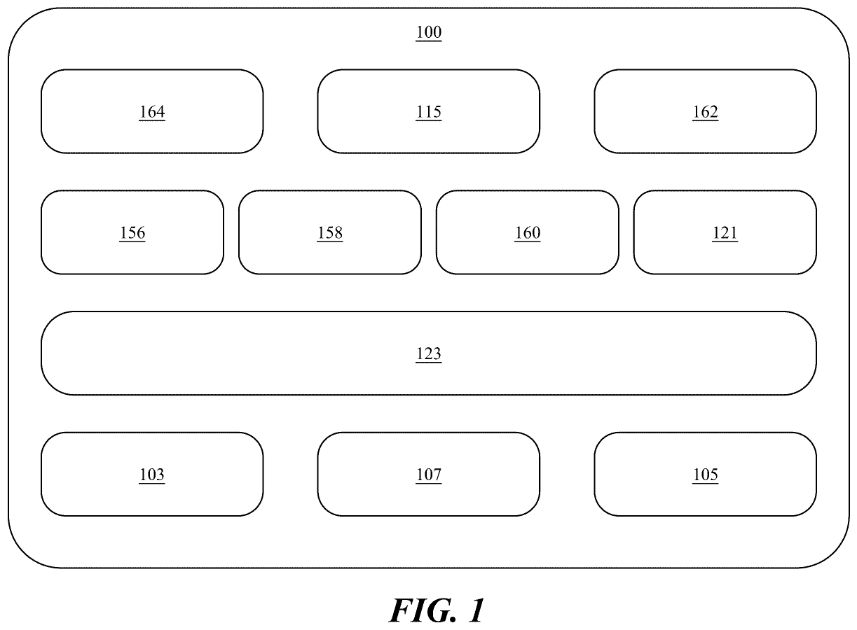

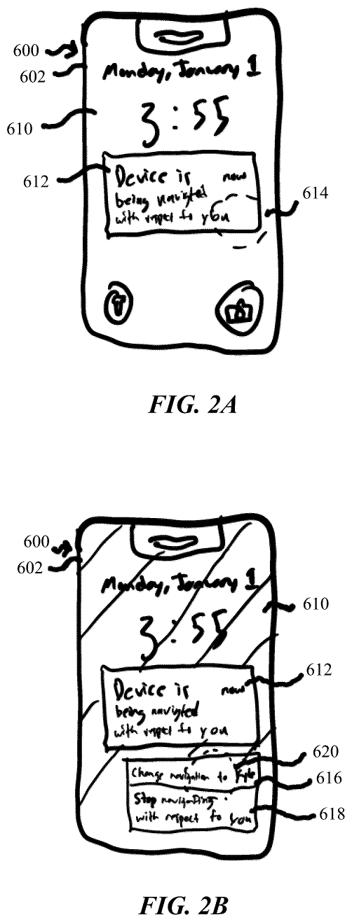

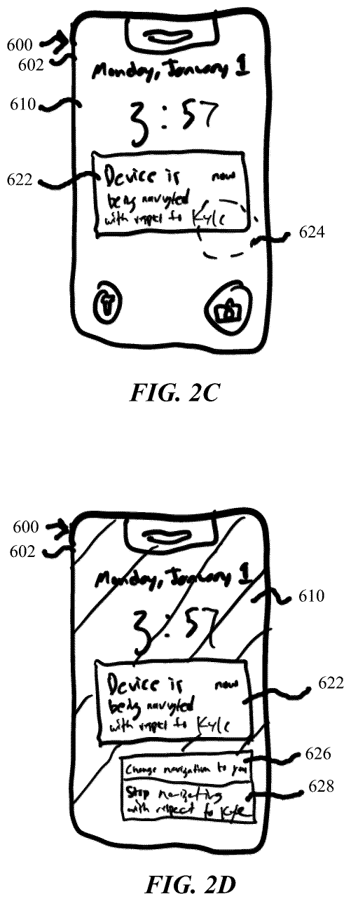

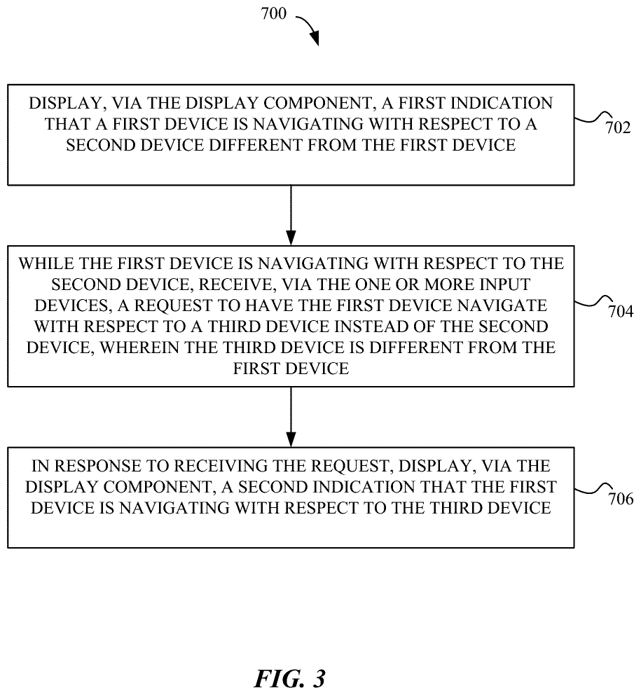

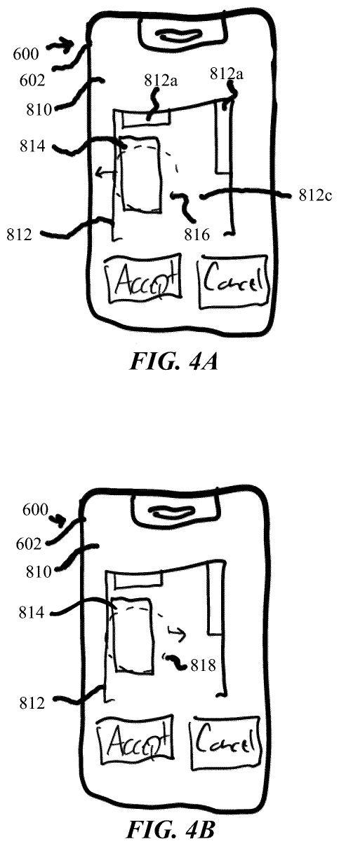

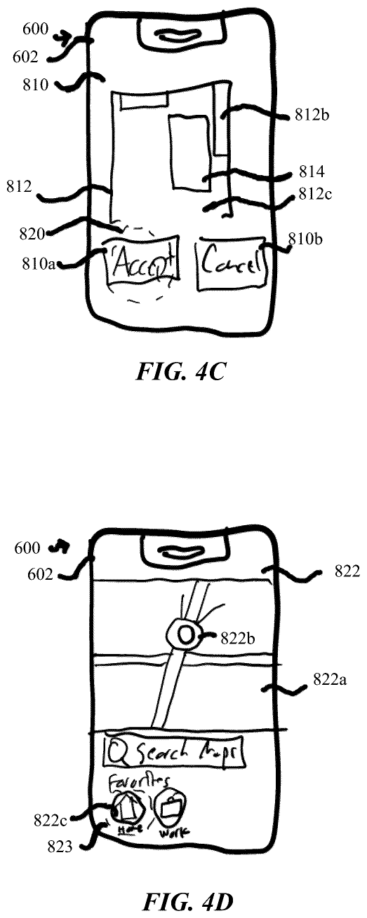

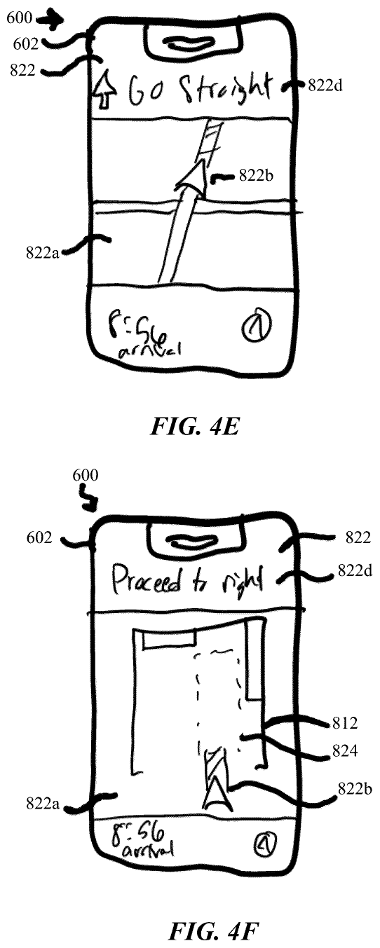

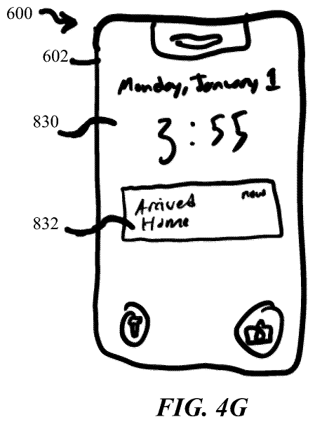

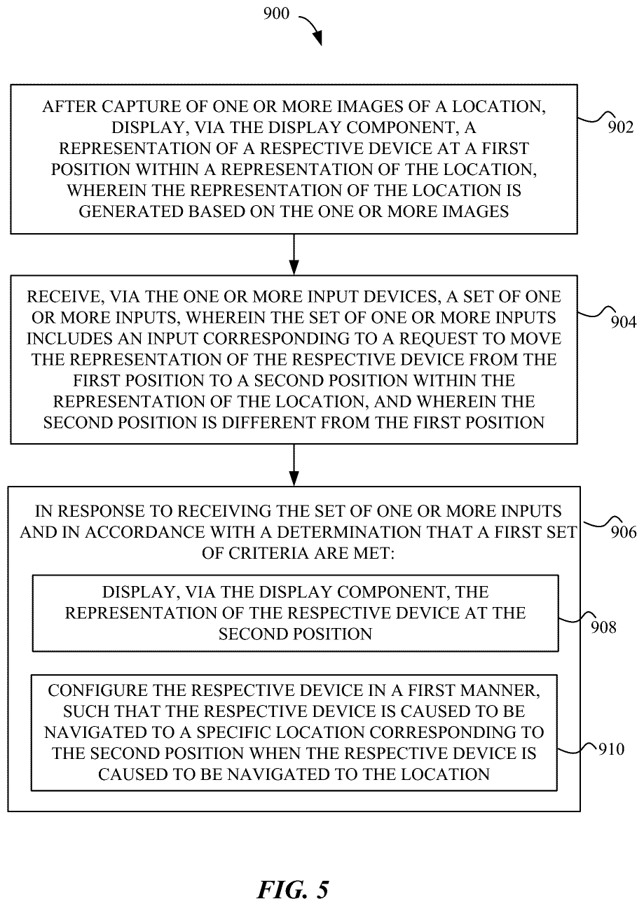

FIG. 1 provides illustrations of exemplary devices for performing techniques for configuring navigation of a device. FIGS. 2A-6G illustrate exemplary user interfaces for navigating a first device with respect to a second device in accordance with some embodiments. FIG. 3 is a flow diagram illustrating methods of navigating a first device with respect to a second device in accordance with some embodiments. The user interfaces in FIGS. 2A-6G are used to illustrate the processes described below, including the processes in FIG. 3. FIGS. 4A-4D illustrate exemplary user interfaces for configuring a device to navigate to a specific location in accordance with some embodiments. FIG. 5 is a flow diagram illustrating methods of configuring a device to navigate to a specific location in accordance with some embodiments. The user interfaces in FIGS. 4A-4D are used to illustrate the processes described below, including the processes in FIG. 5.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3 and/or 4 (e.g., processes 700 and/or 900) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environmental controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2D illustrate exemplary user interfaces for navigating a first device with respect to a second device in accordance with some embodiments. FIG. 3 is a flow diagram illustrating methods for navigating a first device with respect to a second device in accordance with some embodiments. The user interfaces in FIGS. 2A-2D are used to illustrate the processes described below, including the processes in FIG. 3.

FIGS. 2A-2D illustrate exemplary user interfaces for navigating a first device with respect to a second device in a physical environment, in accordance with some embodiments. The user interfaces in these figures are used to illustrate the processes described below, including the processes in FIG. 3. Throughout the user interfaces, user input is illustrated using a circular shape with dotted lines (e.g., touch user input 614 in FIG. 2A). It should be recognized that the user input can be any type of user input, including a tap on touch-sensitive screen, a button press, a gaze toward a control, a voice request with an identification of a control, a gesture made by a user and captured by a camera, and/or any other affirmative action performed by a user. In some examples, a single representation of a user input in a figure (1) includes one or more different types of user input and/or (2) represents different types of user input to result in different operations. For example, a single illustrated user input can be a tap input, a tap-and-hold input, and/or a swipe gesture.

FIG. 2A illustrates user interface 610 for navigating a first device with respect to a second device using computer system 600 in accordance with some embodiments. In this example, computer system 600 includes a touchscreen display 602. In some embodiments, computer system 600 is, or includes one or more of the features of, system 100 described above.

In FIG. 2A, computer system 600 displays user interface 610 on touchscreen display 602. User interface 610 includes navigation control user interface element 612. User interface 610 is a lock screen interface, displaying time and date, as well as navigation control user interface element 612 presented as an overlay or notification. In other examples, a user interface that includes navigation control user interface element 612 can include a maps or navigation application interface (e.g., such that navigation control user interface element 612 is a native interface inside of such application), or any other application or operating system interface (e.g., overlaid as a notification). Navigation control user interface element 612 includes an indication that another device (a “first” device in this example) is navigating with respect to computer system 600 (a “second” device in this example) where it states that: “Device is being navigated with respect to you.” The use of the phrase “you” indicates that the first device is navigating with respect to the current user of computer system 600 (e.g., based on the user being logged in), or is navigating with respect to the current device on which the notification is being displayed (e.g., computer system 600, regardless of user affiliation). Navigation control user interface element 612 can include one or more controls (e.g., affordances, buttons, and/or icons) or be configured to receive user input some other way, for causing one or more actions. In this example, the entire displayed area of navigation control user interface element 612 can receive user input to cause an action. In FIG. 2A, computer system 600 receives a touch user input 614 (e.g., a tap, a tap-and-hold, or a hard press) on an operative portion (e.g., the displayed area) of navigation control user interface element 612.

The example illustrated in FIG. 2A-2D is applicable to many different scenarios. In some embodiments, the first device is associated with a different user than the second device. For example, the first device can have been instructed to navigate with respect to the second device. In some embodiments, the instruction originates from the first device (e.g., by a user of the first device (e.g., “follow that device”)), and/or the second device (e.g., by a user of the second device (e.g., “follow me”)). In some embodiments, the instruction can originate from another device (e.g., third device) that is not the first or second device. The second device can belong to a member of a particular group, (e.g., of devices (e.g., “my devices”), of users (e.g., family group, friend group, or any arbitrarily defined group), or any other permitted user that the first device user would like to navigate with respect to (e.g., a recent contact, a message recipient or sender, a contact that has shared their location, or the like)).

In some embodiments, the first device is associated with the same user as the second device. For example, the user of the second device can instruct one of their own devices (e.g., associated with their same user account) that has the ability to change position (e.g., a toy and/or a drone) to navigate to the user's current device (e.g., smartphone) location or the location of another device. Navigating with respect to another device can include providing and/or receiving directions to (or being led to) a location corresponding to the other device. In some embodiments, the location corresponding to the other device is the location of the other device (e.g., the same location). In some embodiments, the location corresponding to the other device is a location within a predetermined distance from the other device (e.g., a different location, such as a safe area near the other device). For example, the first device can navigate to a location adjacent to the second device, so that the devices are close enough that a user could go to the first device when needed but not so close that the first device is on top of or collides with the user (e.g., holding the second device). In some embodiments, the device being navigated can receive location information and/or step-by-step instructions to the other device, so that it will end up at the location of the device being navigated to. In some embodiments, the device being navigated to (or another device) can provide location information and/or step-by-step instructions that periodically update so that the device being navigated can follow and/or eventually reach the device being navigated to. The device being navigated can receive updated location information of the target device by direct communication (e.g., with each other) or via one or more intermediate systems (e.g., a notification server).

FIG. 2B illustrates computer system 600 in response to receiving touch user input 614. In this example, a user of computer system 600 would like to control navigation of the first device to navigate with respect to a different, third device (e.g., not computer system 600). In response to touch user input 614, computer system 600 displays navigation control user interface elements 616 and 618. Also, in response to touch user input 614, computer system 600 alters the display of user interface element 610 by dimming or darkening in order to emphasize that action is being taken with respect to interface elements 612, 616, and 618.

Navigation control user interface element 616 includes an indication that navigation of the first device can be changed to another device (e.g., computer system), where it states: “Change navigation to Kyle”. In this example, the other device (e.g., a “third” device in this example) is identified by the name of a user associated with the third device (e.g., the user named “Kyle” in this example). As shown, user interface element 616 indicates an option to transfer navigation to another particular device. In some embodiments, navigation control user interface element 616 can indicate or provide a plurality of options for selecting one of a group of devices to which navigation can be transferred (e.g., by stating instead “Change navigation to another user or device,” which when selected can display a plurality of user or device options). In some embodiments, the indication that navigation of the first device can be changed to another device (e.g., computer system) can be an icon and/or identifier of a user account (e.g., corresponding to a contact from a contacts application and/or an address book application). In some embodiments, the indication that navigation of the first device can be changed to another device can be an icon and/or identifier of a specific device (e.g., determined using a communication channel, such an identifier of a device that is broadcast via a Bluetooth channel to other devices when in range). In some embodiments, information used for determining another device is retrieved from one or more local and/or remote resources (e.g., from a cloud storage service and/or a location service).

User interface 610 also includes navigation control user interface element 618, which includes an indication that navigation with respect to the second device can be stopped, where it states: “Stop navigating with respect to you”. Here, “you” indicates that the current device is being used as the target navigation for the first device. For example, user input on navigation control user interface element 618 can cause navigation with respect to computer system 600 to stop (e.g., and display of interface elements 612, 616, and 618 to cease). In FIG. 2B, computer system 600 receives a touch user input 620 (e.g., a tap, a tap-and-hold, or a hard press) on an operative portion (e.g., any portion in this example) of navigation control user interface element 616.

FIG. 2C illustrates computer system 600 in response to receiving touch user input 620. In this example, a user of computer system 600 would like to transfer the first device to navigate with respect to a different, third device (e.g., not computer system 600). In response to touch user input 620, computer system 600 displays navigation control user interface element 622 and ceases displaying navigation control user interface element 612. Also, in response to touch user input 620, computer system 600 causes the first device to cease navigating with respect to computer system 600 and begin navigating with respect to the third device. As illustrated in FIG. 2C, navigation control user interface element 622 includes an indication that navigation of the first device has been changed to another device (e.g., another computer system), where it states: “Device is being navigated with respect to Kyle.” In this example, the other device is associated with the user identified as “Kyle.”

In the example of FIG. 2C, the first device and the second device are associated with one or more user accounts (e.g., the same account and/or different accounts) that are not the same as (and do not include) the Kyle user account. Stated differently, the Kyle account corresponds to a different user account than the owner of the first device and the second devices. In this example, navigation with respect to the third device will result in navigating with respect to a device corresponding to (e.g., owned and/or managed) by a different user account than of the first device and second device. In some embodiments, designating the device associated with Kyle as the target of the first device's navigation results in the user account of Kyle and/or Kyle's device being designated a “guest” user/device of the second device. That is, when Kyle's device is made the target of navigation, Kyle's device can be granted (e.g., by the first device and/or by the second device, or users associated therewith) the right to perform one or more operations for controlling navigation of the first device. For example, the third device can be granted one or more of the abilities to: cease navigation with respect to themselves/their device (e.g., “don't navigate with respect to me”), return the navigation target to the user and/or device that sent it to them (e.g., “navigate with respect to the second device again”), or assign navigation to another user or associated device (e.g., “don't navigate with respect to me, navigate with respect to a fourth (different) device instead”). This grant of rights to the third device can be temporary (e.g., expires after predefined amount of time, or after a condition occurs or is met). In this example, the second device was not designated a “guest” because it corresponds to the same user account as the first device (and/or the user account and/or the second device are already established as an administrator (e.g., having a non-guest privilege level) for the first device). The first, second, and/or third devices can each be different types of devices. In this example, the second device (computer system 600) is a smartphone, the first device is a wearable device (that moves via user movement), and the third device is a laptop computer.

In FIG. 2C, computer system 600 receives a touch user input 624 (e.g., a tap, a tap-and-hold, or a hard press) on an operative portion (e.g., any portion in this example) of user interface element 622.

FIG. 2D illustrates computer system 600 in response to receiving touch user input 624. In response to touch user input 624, computer system 600 displays navigation control user interface elements 626 and 628. Also, in response to touch user input 624, computer system 600 alters the display of user interface 310 by dimming or darkening in order to emphasize that action is being taken with respect to interface elements 622, 626, and 628. Navigation control user interface element 626 includes an indication that the navigation target of the first device can be changed (back) to the second device (e.g., computer system 600), where it states: “Change navigation to you.” For example, a user input (such as 624) on navigation control user interface element 626 would cause computer system 600 to return to the state shown in FIG. 2A, where it displays navigation control user interface element 612 indicating that the first device is navigating with respect to computer system 600 (e.g., represented as “you”).

Navigation control user interface element 628 includes an indication that navigation of the first device with respect to the third device (e.g., computer system 600) can be stopped, where it states: “Stop navigating with respect to Kyle”. For example, a user input (such as 624) on user interface element 628 would cease navigation of the first device with respect to the third device associated with Kyle (e.g., navigation instructions would cease at the first device). For example, in response to user input on user interface element 628, computer system 600 can display user interface 610 without displaying navigation control user interface element 612 (e.g., just display a normal lock screen).

FIG. 3 is a flow diagram illustrating a method for navigating a first device with respect to a second device using a computer system in accordance with some embodiments. Process 700 is performed at a computer system (e.g., system 100). The computer system is in communication with a display component and one or more input devices. Some operations in process 700 are, optionally, combined, the orders of some operations are, optionally, changed, and some operations are, optionally, omitted.

As described below, process 700 provides an intuitive way for navigating a first device with respect to a second device. The method reduces the cognitive burden on a user for navigating a first device with respect to a second device, thereby creating a more efficient human-machine interface. For battery operated computing devices, enabling a user to configure navigation of a device faster and more efficiently conserves power and increases the time between battery charges.

In some embodiments, process 700 is performed at a computer system (e.g., 600) that is in communication with a display component (e.g., 602) (e.g., a display screen and/or a touch-sensitive display) and one or more input devices (e.g., 602) (e.g., a physical input mechanism, a camera, a touch-sensitive display, a microphone, and/or a button). In some embodiments, the computer system is a watch, a phone, a tablet, a processor, a head-mounted display (HMD) device, and/or a personal computing device. In some embodiments, the computer system is in communication with one or more output devices (e.g., a display screen, a touch-sensitive display, a haptic output device, and/or a speaker).

The computer system displays (702), via the display component, a first indication (e.g., 612 of FIG. 2A) that a first device (e.g., the device referenced in 612 of FIGS. 2A-2D) is navigating with respect to a second device (e.g., 600) different from the first device. In some embodiments, the first indication is displayed on a lock screen of the computer system (e.g., a user interface of the computer system that is configured to be allowed to perform less operations than an unlocked screen of the computer system) (e.g., the lock screen is displayed when the computer system is in a locked state (e.g., the computer system is powered on and operational but ignores most, if not all, input)). In some embodiments, the first indication is displayed in a user interface of a mapping and/or navigation application. In some embodiments, the first device is different from the computer system. In some embodiments, the second device is the computer system. In some embodiments, the second device is different from the computer system. In some embodiments, the computer system is logged into a first user account. In some embodiments, the first device is logged into the first user account. In some embodiments, the first device is logged into a user account different from the first user account. In some embodiments, the second device is logged into the first user account. In some embodiments, the second device is logged into a user account different from the first user account. In some embodiments, navigating with respect to the second device includes navigating to locations corresponding to a current location of the second device as the second device moves. In some embodiments, navigating with respect to the second device includes following the second device.

While the first device (e.g., the device referenced in 612 of FIGS. 2A-2D) is navigating with respect to the second device, the computer system receives (704), via the one or more input devices, a request (e.g., 620) to have the first device navigate with respect to a third device (e.g., device associated with Kyle referenced in 616 of FIG. 2B) instead of the second device (e.g., 600), wherein the third device is different from the first device (e.g., the device referenced in 612 of FIGS. 2A-2D). In some embodiments, the request is received after or while displaying the first indication. In some embodiments, the third device is different from the computer system. In some embodiments, the request corresponds to input directed to a user interface including the first indication. In some embodiments, the third device is logged into a user account different from the first user account. In some embodiments, the third device is logged into the first user account.

In response to receiving the request, the computer system displays (706), via the display component, a second indication (e.g., 622 of FIGS. 2C and/or 2D) that the first device (e.g., the device referenced in 612 of FIGS. 2A-2D) is navigating with respect to the third device (e.g., device associated with Kyle referenced in 616 of FIG. 2B). In some embodiments, the computer system forgoes navigating with respect to the second device in response to receiving the request. In some embodiments, the second indication is different from the first indication. In some embodiments, the second indication is displayed in the user interface of the mapping and/or navigation application. Allowing the computer system to receive a request to cause the first device to navigate with respect to the third device instead of the second device while the first device is navigating with respect to the second device provides the user the ability to change navigation targets easily and/or efficiently without requiring additional steps to stop following the second device and/or establish a connection with the third device before initiating navigation with respect to the third device, thereby reducing the number of inputs needed to perform an operation, providing additional control options without cluttering the user interface with additional displayed controls, and/or performing an operation when a set of conditions has been met without requiring further user input.

In some embodiments, in response to receiving the request (e.g., 620), the computer system ceases to display the first indication (e.g., 612). In some embodiments, in response to receiving the request, the computer system displays an indication that the first device is not navigating with respect to the second device different from the first device. In some embodiments, in response to receiving the request, the computer system displays an indication that the first device is navigating with respect to the third device different from the second device. Ceasing to display the first indication when switching from navigating with respect to the second device to the third device provides the user with feedback about the state of the computer system, thereby providing improved visual feedback to the user.

In some embodiments, the computer system (e.g., 600) includes the second device (e.g., 600). In some embodiments, the computer system is the second device. In some embodiments, the computer system includes the first device. In some embodiments, the computer system is the first device. In some embodiments, the computer system is the second device and not the first device. In some embodiments, the computer system is not the first device or the second device. The computer system including the second device (e.g., the device for which the first device is no longer navigating with respect to after receiving the request) provides the user with feedback about the state of the first device, thereby providing improved visual feedback to the user.

In some embodiments, receiving the request (e.g., 620) to have the first device (e.g., the device referenced in 612 of FIGS. 2A-2D) navigate with respect to the third device (e.g., device associated with Kyle referenced in 616 of FIG. 2B) includes detecting input (e.g., 620) (e.g., a tap gesture, a long-press gesture, a verbal request and/or command, a physical button press, an air gesture, and/or a rotation of a physical input mechanism) directed to a control (e.g., 616) that includes an indication of the third device. In some embodiments, the indication includes an indication of a user associated with the third device. Having the control (e.g., the control that causes the first device to navigate with respect to the third device instead of the second device) include the indication of the third device provides the user with feedback about the state of the first device and information for how the control will affect the first device, thereby providing additional control options without cluttering the user interface with additional displayed controls and/or providing improved visual feedback to the user.

In some embodiments, while the first device is navigating with respect to the third device (e.g., device associated with Kyle referenced in 616 of FIG. 2B), the computer system displays, via the display component, a second control (e.g., 626) that includes an indication of the second device (e.g., 600), wherein the second control is different from the control (e.g., 616). In some embodiments, while displaying the second control, the computer system receives input (e.g., input on 626) (e.g., a tap gesture, a long-press gesture, a verbal request and/or command, a physical button press, an air gesture, and/or a rotation of a physical input mechanism) directed to the second control. In some embodiments, in response to receiving the input directed to the second control, the computer system displays, via the display component, a third indication (e.g., display navigation control user interface element 612 as in FIG. 2A) (e.g., the first indication or a different indication) that the first device (e.g., the device referenced in 612 of FIGS. 2A-2D) is navigating with respect to the second device. In some embodiments, in response to receiving the input directed to the second control, forgoing displaying the second indication. Displaying the second control while the first device is navigating with respect to the third device provides the user the ability to change navigation targets easily and/or efficiently without requiring additional steps to stop following the third device and/or establish a connection with the second device before initiating navigation with respect to the second device, thereby reducing the number of inputs needed to perform an operation, providing additional control options without cluttering the user interface with additional displayed controls, and/or performing an operation when a set of conditions has been met without requiring further user input.

In some embodiments, in response to receiving the request, the computer system classifies the third device (e.g., device associated with Kyle referenced in 616 of FIG. 2B) as a guest user (e.g., a user that is not associated with the first device and/or an account that is associated with the first device) of the first device (e.g., the device referenced in 612 of FIGS. 2A-2D) (e.g., without classifying the third device as a guest user of the second device). In some embodiments, the first device is classified as a different type of user of the first device than a guest user. In some embodiments, classifying the third device as a guest user of the first device configures the third device to be able to perform one or more first operations with respect to the first device, wherein the second device is configured to be able to perform one or more second operations with respect to the first device, wherein the one or more second operations includes at least one different operation than the one or more first operations. Classifying the third device as a guest user provides the user the ability to change navigation targets with different devices without needing to classify the different devices as administrators and/or take ownership of the first device, thereby improving security.

In some embodiments, the third device is classified as the guest user of the first device (e.g., the device referenced in 612 of FIGS. 2A-2D) for a predefined amount of time (e.g., 1-45 minutes). In some embodiments, the third device (e.g., device associated with Kyle referenced in 616 of FIG. 2B) is no longer classified as a guest user of the first device after the predefined amount of time has lapsed. In some embodiments, the predefined amount of time is set by a non-guest user that is associated with the first device. Classifying the third device as a guest user for the predefined amount of time and no longer classifying the third user as the guest user after the predefined amount of time provides a time limit for such classification that prevents the third device from taking over the first device, thereby improving security.

In some embodiments, the second device (e.g., 600) is a different type (e.g., a phone, a watch, a speaker, a device that can move without assistance (e.g., a device with a movement mechanism, such as a wheel, pulley, axel, engine, and/or a motor), and/or a device that cannot move without assistance) of device than the first device. In some embodiments, the third device (e.g., device associated with Kyle referenced in 616 of FIG. 2B) is a different type of device than the first device (e.g., the device referenced in 612 of FIGS. 2A-2D). In some embodiments, the second device includes one or more capabilities that the first device does not include. In some embodiments, the first device includes one or more capabilities that the second device does not include. In some embodiments, the first device is in communication with a component that the second device is not in communication with. In some embodiments, the second device is in communication with a component that the first device is not in communication with. In some embodiments, the third device includes one or more capabilities that the first device does not include. In some embodiments, the first device includes one or more capabilities (e.g., the first device is able to move without assistance while the third device is not able to move without assistance, the first device includes a component and/or sensor that the third device does not include, and/or the first device is able to output content of a particular type that the third device is not able to output) that the third device does not include. In some embodiments, the first device is in communication with a component that the third device is not in communication with. In some embodiments, the third device is in communication with a component that the first device is not in communication with. Having the second and third device be different types of devices than the first device allows the user to use different types of devices as targets for navigation for the first device without all of the devices needing to be the same type of device, thereby reducing friction when controlling different devices and/or allowing personal devices to control other types of devices.

Note that details of the processes described above with respect to process 700 (e.g., FIG. 3) are also applicable in an analogous manner to the methods described below/above. For example, process 900 optionally includes one or more of the characteristics of the various methods described above with reference to process 700. For example, the respective device of process 900 can be the first device of process 700. For brevity, these details are not repeated below.

FIGS. 4A-4G illustrate exemplary user interfaces for configuring a device to navigate to a specific location in accordance with some embodiments. FIG. 5 is a flow diagram illustrating methods for configuring a device to navigate to a specific location in accordance with some embodiments. The user interfaces in FIGS. 4A-4G are used to illustrate the processes described below, including the processes in FIG. 5. Throughout the user interfaces, user input is illustrated using a circular shape with dotted lines (e.g., user input 816 in FIG. 4A). It should be recognized that the user input can be any type of user input, including a tap on touch-sensitive screen, a button press, a gaze toward a control, a voice request with an identification of a control, a gesture made by a user and captured by a camera, and/or any other affirmative action performed by a user. In some examples, a single representation of a user input in a figure (1) includes one or more different types of user input and/or (2) represents different types of user input to result in different operations. For example, a single illustrated user input can be a tap input, a tap-and-hold input, and/or a swipe gesture.

FIG. 4A illustrates user interface 810 for configuring a device to navigate to a specific location within a physical environment using computer system 600 in accordance with some embodiments. In this example, computer system 600 includes one or more of the features described above with respect to FIGS. 2A-2D.

In FIG. 4A, computer system 600 displays, on touchscreen display 602, user interface 810, which includes a representation 812 of a physical space and a representation 814 of a target device located within the physical space. In this example, the “target” device is the device for which navigation is configured using the interfaces described with respect to FIGS. 4A-4G. In some embodiments, the target device corresponding to the representation of the respective device is a particular vehicle corresponding to a particular unique identifier. In some embodiments, the target device corresponding to the representation of the device is a respective device (e.g., a smartphone, a laptop, and/or a wearable device) being used with the navigation application.

In some embodiments, computer system 600 receives (e.g., captured by one or more other devices, or captured by computer system 600 (e.g., via imaging and/or scanning equipment such as one or more cameras and one or more depth sensors)) data (e.g., images and/or video) representing a physical environment. For example, a user of computer system 600 can use one or more connected camera, lidar, radar, and/or other depth sensor to scan their garage and/or create (or cause creation of) representation 812, a digital multi-dimensional (e.g., 3-D, 2-D) representation of their garage. In this example, representation 812 includes objects 812a and 812b, representing objects in the physical space that occupy portions of floor space 812c. Representation 812 also includes floor space 812c representing an area of the physical space on which a target device can be configured to navigate to (e.g., if no other objects or devices occupy such space). In some embodiments, user interface 810 is an interface of an application (e.g., a navigation application, a device configuration application) or of an operating system of the device (e.g., a lock screen interface).

In the scenario depicted in FIG. 4A, a user of computer system 600 scans their garage without a target device located inside of it, and subsequently views their respective representations 812 (garage) and 814 (target device). For example, a user can use computer system 600 to capture one or more images and/or depth measurements from within the garage, which are then used to create representation 812 (e.g., stitched together into a model). In some embodiments, after (e.g., in response to) scanning the garage, computer system 600 displays a representation of the garage (e.g., representation 812). In some embodiments, representation 812 is an image of the garage that is a composite of one or more images (e.g., taken during the scan).

After initially scanning the garage without the target device, computer system 600 can display representation 812 of the garage. After scanning, the user interface (representation 812) might not initially have a representation of the target device within it. In some embodiments, a user of computer system 600 scans the target device in a separate scan (e.g., a second scan). In some embodiments, a user of computer system 600 selects (e.g., via user input received by computer system 600) a representation of the target device (e.g., selects by providing identifying information and/or dimensions). In some embodiments, once respective representations for the garage and the target device are attained, the target device is assigned to a particular location (e.g., area) within the garage (e.g., that is determined to be an optimal location based on the respective dimensions of the garage and the target device) It should be recognized that other embodiments include the user of computer system 600 scanning their garage with the target device inside of it.

FIG. 4A depicts representation 814 at an example first position (of representation 812). However, in this example a user of computer system 600 desires to configure a different position of the target device represented by representation 814 within the garage represented by representation 812, so that future navigation of the target device will navigate to the configured different (e.g., second) position. In other words, at some time in the future the user wants to instruct computer system 600 to navigate to the location “Home” while driving their car (e.g., represented by representation 814) and cause a navigation function to remember a precise navigation location configured using user interface 810 (and subsequently navigate representation 814 to the configured location). Techniques for such user interfaces are described below.

In FIG. 4A, computer system 600 receives a user input 816 (e.g., a tap, a tap-and-hold (e.g., with movement), or a hard press) on representation 814. As shown in FIG. 4A, user input 816 includes movement to the left (e.g., a tap-and-hold input, followed by a drag to the left). In some embodiments, user interface 810 does not allow invalid movement of a target device representations. In this example, because representation 814 is already as close to the barrier (e.g., wall) of representation 812, representation 814 does not move further to the left. In some embodiments, an indication is provided that indicates an invalid movement (e.g., to the left in FIG. 4A), such as foregoing displaying the instructed movement (e.g., stops representation 814 at a safe distance from the left wall) and/or outputting one or more of a sound, audible message, haptic, or visual notification.

In FIG. 4B, computer system 600 receives user input 818 (e.g., a tap, a tap-and-hold (e.g., with movement), or a hard press) on representation 814. As shown in FIG. 4B, user input 818 includes movement to the right (e.g., a tap-and-hold, followed by a drag to the right). In contrast to FIG. 4A and user input 816, because there is unoccupied space on floor space 812c to the right of representation 814, representation 814 can move to the right (e.g., be dragged by user input 818) because it is a valid movement.

FIG. 4C illustrates computer system 600 in response to receiving user input 818 in accordance with some embodiments. In response to touch user input 818, computer system 600 displays representation 814 shifted to the right with respect to floor space 812c in representation 812. In this example, the representation of object 812b establishes a rightward barrier for placement of representation 814 within representation 812. For instance, object 812b can represent shelving that a target device, represented by 814, cannot occupy-thus, user interface 810 and representation 812 will not allow representation 814 to be placed occupying the same space as object 812b. In some embodiments, user interface 810 includes one or more affordances for accepting (e.g., configuring, saving) a precise navigation position represented by representation 814 and/or for not accepting the precise navigation position. For example, in FIG. 4C, user interface 810 includes accept affordance 810a (for accepting the current position of 814 as the precise navigation position for the target device represented by representation 814). In this example, user interface 810 also includes cancel affordance 810b (for rejecting the current position of 814 as the precise navigation position for the target device represented by representation 814). In some embodiments, selection of cancel affordance 810b causes user interface 810 to cease to be displayed. In some embodiments, selection of cancel affordance 810b causes the target device to be configured to navigate to a precise navigation position that was configured prior to displaying user interface 810 (e.g., prior to beginning a process for editing the precise navigation position). In FIG. 4C, computer system 600 receives a touch user input 820 (e.g., a tap, a tap-and-hold, or a hard press) on accept affordance 810a. In response to touch user input 820 (e.g., after completion of the input), computer system 600 configures a precise navigation position to be associated with representation 814 at the “second” position, which is shown in FIG. 4C shifted to the right with respect to floor space 812c in representation 812.

FIG. 4D illustrates navigation user interface 822 in accordance with some embodiments. Navigation user interface 822 includes map portion 822a (representing a geographic area), indicator 822b (representing a current location of computer system 600 within map portion 822a), and home affordance 822c (representing a saved/configured precise navigation position at the user's configured “Home” location). In this example, after configuring a precise navigation location for their vehicle inside of their home garage, the user of computer system 600 desires to navigate their vehicle home to the configured precise navigation location (represented by home affordance 822c). Exemplary techniques for performing such actions in accordance with some embodiments are now described. In FIG. 4D, computer system 600 receives a touch user input 823 (e.g., a tap, a tap-and-hold, or a hard press) on home affordance 822c.

FIG. 4E illustrates computer system 600 in response to receiving touch user input 823 in accordance with some embodiments. In response to touch user input 823, computer system 600 displays navigation user interface 822 as shown in FIG. 4E. In FIG. 4E, the appearance of navigation user interface 822 has changed because the navigation application is performing an active navigation instruction process. As shown in FIG. 4E, navigation user interface 822 includes map portion 822a and indicator 822b (e.g., updated to an arrow to indicate current position and direction of travel), as well as navigation instruction field 822d (which includes a current navigation instruction (e.g., “Go Straight”)).

In some embodiments, upon reaching or nearing the precise navigation location (e.g., associated with “Home”), the navigation user interface can change to (or be replaced by) a precise navigation view. FIG. 4F illustrates navigation user interface 822 arranged in a precision navigation view, in accordance with some embodiments, and includes representation 812 of the physical space of the user's garage. As shown in FIG. 4F, navigation user interface 822 includes map portion 822a and indicator 822b (e.g., optionally updated to include an indication of the current vehicle's dimensions (e.g., the rectangular shaped portion) and direction of travel (e.g., the arrow)). Also, in FIG. 4F, navigation user interface 822 includes an updated navigation instruction field 822d, instructing that navigation should proceed to the right (“Proceed to right”), and (optionally) a precision navigation target 824. In some embodiments, precision navigation target 824 indicates where the user of the navigation user interface should place the vehicle or object being navigated (e.g., park the car). In this example, precision navigation target 824 is an area or shape that corresponds to the scanned representation 814 of the vehicle (from FIGS. 4A-4C). However, precision navigation target 824 can be any suitable indicator for indicating a location (e.g., a point or shape in space within representation 812, which can or cannot correspond to a point on 822b or 814 that should be correspondingly aligned by moving the represented vehicle (e.g., guiding the user to line up the two points)).

FIG. 4G illustrates navigation completion notification 832 in accordance with some embodiments. Computer system 600 displays navigation completion notification 832 in response to a determination (e.g., after detecting and/or determining, or by receiving an indication from one or more other devices) that the vehicle (e.g., represented by representations 814 and/or 822b) has reached the precision navigation target 824 (e.g., is sufficiently within or near precision navigation target 824, according to some criteria such as distance between points, area of vehicle within precision navigation target 824, or any other suitable criteria). Navigation completion notification 832 indicates arrival at the location selected for navigation (“Home” selected in FIG. 4D), where it states: “Arrived Home.” As shown in FIG. 4G, computer system 600 displays navigation completion notification on a lock screen interface 830 and ceases displaying a navigation interface (e.g., 810, 822). In this example, once precision navigation has completed, the computer system 600 automatically ceases displaying an interface with a full map, representations of a physical space or object(s), and/or navigation instructions, and in its place displays a lock screen (or home screen, or other default or idle state screen) interface with a notification that the journey is complete. In some embodiments, completion of the precise navigation successfully causes the target device to change operation from a first manner (e.g., powered on, in a particular active state) to a second manner (e.g., powered off, or in an idle/inactive/low-power state). In some embodiments, computer system 600 can transmit a message or command that causes the target device to change operation to the second manner of operation. In some embodiments, the target device automatically enters the second manner of operation upon reaching the configured precise navigation location.

In some embodiments, the second device (e.g., 600) is used during subsequent navigation of the first device (e.g., target device). For example, computer system 600 can be a smartphone that detects it is being used with the user's vehicle (e.g., based on connectivity with the vehicle, such as via Bluetooth or a wired connection), and intelligently knows to use the configured precise location for that vehicle (or any vehicle, depending on configuration settings). In such an example, computer system 600 is used to navigate, as illustrated by the examples in FIGS. 4D-4G.

In some embodiments, the second device (e.g., 600) is not used during subsequent navigation of the first device (e.g., target device). In some embodiments, the first device navigates itself to the configured precise location (e.g., in response to receiving an instruction to do so (e.g., from user input and/or from another device)). For example, computer system 600 can be a smartphone that is used to configure the precise location, but the first (e.g., target) device is a device with the ability move itself (e.g., using wheels, tracks, and/or rotors) and perform some level of spatial location and mapping (e.g., alone or assisted by other devices). Thus, as an example, after receiving an instruction to navigate to the configured precise location, a target device that is an autonomous robotic lawnmower can return to a particular place in the garage (e.g., in a safe location that will facilitate charging (e.g., near a power outlet)). The lawnmower can use one or more onboard functions that facilitate location awareness (e.g., GPS, camera, radar, spatial maps, etc.) to navigate to the configured location without needing further intervention by a user or computer system 600 (e.g., to display step-by-step instructions).

FIG. 5 is a flow diagram illustrating a method for configuring a device to navigate to a specific location using a computer system in accordance with some embodiments. Process 900 is performed at a computer system (e.g., system 100). The computer system is in communication with a display component and one or more input devices. Some operations in process 900 are, optionally, combined, the orders of some operations are, optionally, changed, and some operations are, optionally, omitted.

As described below, process 900 provides an intuitive way for configuring a device to navigate to a specific location. The method reduces the cognitive burden on a user for configuring a device to navigate to a specific location, thereby creating a more efficient human-machine interface. For battery operated computing devices, enabling a user to configure a device to navigate to a specific location faster and more efficiently conserves power and increases the time between battery charges.

In some embodiments, process 900 is performed at a computer system (e.g., 600) that is in communication with a display component (e.g., 602) (e.g., a display screen and/or a touch-sensitive display) and one or more input devices (e.g., 602) (e.g., a physical input mechanism, a camera, a touch-sensitive display, a microphone, and/or a button). In some embodiments, the computer system is a watch, a phone, a tablet, a processor, a head-mounted display (HMD) device, and/or a personal computing device. In some embodiments, the computer system is in communication with one or more output devices (e.g., a display screen, a touch-sensitive display, a haptic output device, and/or a speaker).

After capture of (e.g., after the computer system or a different computer system captures) one or more images (e.g., radar, lidar, and/or optical images) of a location (e.g., physical space describe with respect to FIG. 4A) (e.g., a location (e.g., a destination, a destination location, a home location, and/or an arrival location) within a physical environment), the computer system displays (902), via the display component, a representation (e.g., 814) (e.g., a graphical representation, a line, a path, a textual representation, and/or a symbolic representation) of a respective device (e.g., device represented by 814) (e.g., a fitness tracking device, a watch, a phone, a tablet, a processor, a head-mounted display (HMD) device, a vehicle, and/or a personal computing device) at a first position (e.g., position of 814 in FIGS. 4A and/or 4B) within a representation (e.g., 812) of the location (e.g., location represented by 812), wherein the representation of the location is generated based on the one or more images. In some embodiments, the computer system is in communication with one or more cameras. In some embodiments, the one or more cameras are attached to and/or within a housing of the computer system. In some embodiments, the computer system, via one or more cameras in communication with the computer system, captures the one or more images. In some embodiments, the computer system detects, via the one or more input devices, input corresponding to selection of a user-interface element; and in response to detecting the input, initiates a scanning process (e.g., captures, via one or more cameras in communication with the one or more input devices, the one or more images). In such examples, the scanning process is initiated before displaying the vehicle representation. In some embodiments, the computer system is the respective device. In some embodiments, the computer system is different from the respective device.

The computer system receives (904), via the one or more input devices, a set of one or more inputs (e.g., 816 and/or 818), wherein the set of one or more inputs includes an input (e.g., dragging input and/or non-dragging input (e.g., a rotational input, an air gesture, a mouse click, a mouse click and drag input, a voice input, a swipe input, and/or a gaze input)) corresponding to a request to move the representation of the respective device from the first position (e.g., position of 814 in FIGS. 4A and/or 4B) to a second position (e.g., position of 814 in FIG. 4C) within the representation of the location, and wherein the second position is different from the first position. In some embodiments, the input corresponding to the request is received (e.g., and/or detected) while displaying the representation of the location and/or the representation of the respective device.

In response to (906) (e.g., based on and/or in conjunction with) receiving the set of one or more inputs (e.g., 816 and/or 818) (e.g., the input corresponding to the request) and in accordance with a determination that a first set of criteria are met (e.g., a valid movement as described with respect to FIG. 4B), the computer system displays (908), via the display component, the representation (e.g., 814) of the respective device (e.g., device represented by 814) at the second position (e.g., position of 814 in FIG. 4C) (and, in some examples, ceasing display of the representation of the respective device at the first position and/or no longer displaying a representation of the respective device at the first position). In some embodiments, the first set of criteria includes a criterion that is met when the second position is determined to be a valid position. In some embodiments, the first set of criteria includes a criterion that is met when the second position is determined to be navigable to by the respective device.

In response to (906) receiving the set of one or more inputs and in accordance with the determination that the first set of criteria are met, the computer system configures (910) the respective device (e.g., device represented by 814) in a first manner, such that the respective device is caused to be navigated to a specific location (e.g., 824) corresponding to the second position (e.g., position of 814 in FIG. 4C) when the respective device is caused to be navigated to the location (e.g., location represented by 812) (e.g., without being navigated to a specific location corresponding to the first position when the respective device is used to be navigated to the location). In some embodiments, the representation of the respective device is displayed at the second position in response to a first input of the set of one or more inputs and a navigation application is configured to navigate the respective device to the second position in response to a second input (e.g., an input corresponding to accepting the representation of the respective device at the second position) detected after displaying the representation of the respective device at the second position. In some embodiments, the respective device is configured concurrently with displaying the representation of the respective device at the second position. In some embodiments, the respective device corresponding to the representation of the respective device is a particular vehicle corresponding to a particular unique identifier. In some embodiments, the respective device corresponding to the representation of the respective device is a respective device being used with the navigation application. In some embodiments, the respective device is caused to be navigated to a specific location corresponding to the first position when the respective devices is used to be navigated to the location before receiving the set of one or more inputs. Displaying the representation of the respective device at the first position within the representation of the location after capture of the one or more images of the location provides the user with a user interface to visualize the location with reference to the respective device, thereby providing improved visual feedback to the user. Allowing the computer system to receive an input corresponding to a request to move the representation of the respective device from the first position to the second position within the representation of the location provides the user control with where to place the respective device within the location, thereby reducing the number of inputs needed to perform an operation, providing additional control options without cluttering the user interface with additional displayed controls, and/or providing improved visual feedback to the user. Displaying the respective device at the second location and configuring the respective device such that the respective device is caused to be navigated to the specific location corresponding to the second position when the respective device is caused to be navigated to the location provides the user with control with respect to navigating the respective device, thereby reducing the number of inputs needed to perform an operation, providing additional control options without cluttering the user interface with additional displayed controls, performing an operation when a set of conditions has been met without requiring further user input, and/or providing improved visual feedback to the user.

In some embodiments, the respective device (e.g., device represented by 814) is a different type (e.g., phone, watch, speaker, a device that can move without assistance (e.g., a device with a movement mechanism, such as a wheel, pulley, axel, engine, and/or a motor), and/or a device that cannot move without assistance) of device than the computer system. In some embodiments, the respective device includes one or more capabilities that the computer system does not include. In some embodiments, the computer system includes one or more capabilities that the respective device does not include. In some embodiments, the computer system is in communication with a component that the respective device is not in communication with. In some embodiments, the respective device is in communication with a component that the computer system is not in communication with. Having the respective device be a different type of devices than the computer system allows the user to use different types of devices to configure the respective device, thereby reducing friction when configuring the respective device and/or allowing personal devices to configure other types of devices.

In some embodiments, before receiving the set of one or more inputs (e.g., 816 and/or 818), the computer system configures the respective device (e.g., device represented by 814), such that the respective device is caused to be navigated to a location (e.g., a particular and/or specific location) corresponding to the first position in conjunction with (e.g., when, before, immediately before, after, and/or immediately after) the respective device is caused to be navigated to the location. Configuring the respective device before receiving the set of one or more inputs such that the respective device is caused to be navigated to the location corresponding to the first position provides the user with control with respect to navigating the respective device, thereby reducing the number of inputs needed to perform an operation, providing additional control options without cluttering the user interface with additional displayed controls, and/or performing an operation when a set of conditions has been met without requiring further user input.

In some embodiments, in response to (e.g., based on and/or in conjunction with) receiving the set of one or more inputs (e.g., 816 and/or 818) (e.g., the input corresponding to the request) (e.g., one or more dragging inputs or, in some examples, one or more non-dragging inputs (e.g., a rotational input, an air gesture, a mouse click, a mouse click and drag input, a voice input, a swipe input, and/or a gaze input)), the computer system configures the respective device (e.g., device represented by 814) in a second manner, such that the respective device transitions to a reduced power state (e.g., as described with respect to FIG. 4G) (e.g., a low-power or off state) when at the location corresponding to the second position (e.g., position of 814 in FIG. 4C), wherein the second manner is different from the first manner. Configuring the respective device such that the respective device transitions to the reduced power when at the location corresponding to the second position provides the user with control of operations performed by the respective device, thereby reducing the number of inputs needed to perform an operation, providing additional control options without cluttering the user interface with additional displayed controls, and/or performing an operation when a set of conditions has been met without requiring further user input.

In some embodiments, after configuring the respective (e.g., device represented by 814) device in response to receiving the set of one or more inputs (e.g., 816 and/or 818) and in accordance with a determination that the respective device has arrived at the specific location (e.g., 824 of FIG. 4F) corresponding to the second position (e.g., position of 814 in FIG. 4C), the computer system displays, via the display component, a notification (e.g., 832) that the respective device has reached the location. In some embodiments, the notification includes an indication that the respective device has reached the specific location corresponding to the second position. Displaying the notification that the respective device has reached the location when the respective device has arrived at the specific location corresponding to the second position provides the user with information with respect to a state of the respective device, thereby reducing the number of inputs needed to perform an operation, performing an operation when a set of conditions has been met without requiring further user input, and/or providing improved visual feedback to the user.

In some embodiments, in response to (e.g., based on and/or in conjunction with) receiving the set of one or more inputs (e.g., 816 and/or 818) (e.g., the input corresponding to the request) and in accordance with a determination that the first set of criteria are not met, the computer system forgoes configuring (e.g., as described above with respect to user input 816 of FIG. 4A) the respective device in the first manner (and, in some examples, in the second manner). In some embodiments, in response to receiving the set of one or more inputs and in accordance with the determination that the first set of criteria are not met, forgoing displaying the representation of the respective device at the second position. In some embodiments, in response to receiving the set of one or more inputs and in accordance with the determination that the first set of criteria are not met, displaying, via the display component, an indication that the second position is not a valid position. In some embodiments, in response to receiving the set of one or more inputs and in accordance with the determination that the first set of criteria are not met, maintaining display of the representation of the respective device at the first position. In some embodiments, the first set of criteria are not met when the specific location corresponding to the second position is determined not to be a safe and/or possible location for navigation. Forgoing configuring the respective device in the first manner when the first set of criteria are not met prevents the user from being able to configure the respective device to navigate to any location and instead require that a location meet the first set of criteria, thereby reducing the number of inputs needed to perform an operation, performing an operation when a set of conditions has been met without requiring further user input, and/or providing improved visual feedback to the user.

In some embodiments, before displaying the representation (e.g., 812 of FIG. 4A) of the location, the computer system receives a request to capture an image (e.g., as described above with respect to FIG. 4A). In some embodiments, the computer system is in communication with one or more cameras, and the request to capture the image is a request to capture the image via the one or more cameras. In some embodiments, in response to receiving the request, the computer system causes capture (e.g., as described above with respect to FIG. 4A) (e.g., and/or initiating a scan), via a camera in communication with the computer system, of a first image, wherein the one or more images includes the first image. In some embodiments, in response to receiving the request, the computer system captures a plurality of images that includes the first image. In some embodiments, receiving the request to capture the image includes detecting an input (e.g., a tap input or, in some examples, a non-tap input (e.g., a rotational input, an air gesture, a mouse click, a mouse click and drag input, a voice input, a swipe input, and/or a gaze input)) directed to a user interface displayed via the computer system. Capturing the first image that is used to generate the representation using the camera that is in communication with the computer system provides the user to ensure that the representation is for the right location, thereby reducing the number of inputs needed to perform an operation and/or providing improved visual feedback to the user.

Note that details of the processes described above with respect to process 900 (e.g., FIG. 5) are also applicable in an analogous manner to the methods described below/above. For example, process 700 optionally includes one or more of the characteristics of the various methods described above with reference to process 900. For example, the respective device of process 900 can be the first device of process 700. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a display component and one or more input devices:
after capture of one or more images of a location, displaying, via the display component, a representation of a respective device at a first position within a representation of the location, wherein the representation of the location is generated based on the one or more images;
receiving, via the one or more input devices, a set of one or more inputs, wherein the set of one or more inputs includes an input corresponding to a request to move the representation of the respective device from the first position to a second position within the representation of the location, and wherein the second position is different from the first position; and
in response to receiving the set of one or more inputs and in accordance with a determination that a first set of criteria are met:
displaying, via the display component, the representation of the respective device at the second position; and
configuring the respective device in a first manner, such that the respective device is caused to be navigated to a specific location corresponding to the second position when the respective device is caused to be navigated to the location.

2. The method of claim 1, wherein the respective device is a different type of device than the computer system.

3. The method of claim 1, further comprising:
before receiving the set of one or more inputs, configuring the respective device, such that the respective device is caused to be navigated to a location corresponding to the first position in conjunction with the respective device is caused to be navigated to the location.

4. The method of claim 1, further comprising:
in response to receiving the set of one or more inputs, configuring the respective device in a second manner, such that the respective device transitions to a reduced power state when at the location corresponding to the second position, wherein the second manner is different from the first manner.

5. The method of claim 1, further comprising:
after configuring the respective device in response to receiving the set of one or more inputs and in accordance with a determination that the respective device has arrived at the specific location corresponding to the second position, displaying, via the display component, a notification that the respective device has reached the location.

6. The method of claim 1, further comprising:
in response to receiving the set of one or more inputs and in accordance with a determination that the first set of criteria are not met, forgoing configuring the respective device in the first manner.

7. The method of claim 1, further comprising:
before displaying the representation of the location, receiving a request to capture an image; and
in response to receiving the request, causing capture, via a camera in communication with the computer system, of a first image, wherein the one or more images includes the first image.

8. A non-transitory computer-readable storage medium storing one or more programs configured to be executed by one or more processors of a computer system that is in communication with a display component and one or more input devices, the one or more programs including instructions for:
after capture of one or more images of a location, displaying, via the display component, a representation of a respective device at a first position within a representation of the location, wherein the representation of the location is generated based on the one or more images;
receiving, via the one or more input devices, a set of one or more inputs, wherein the set of one or more inputs includes an input corresponding to a request to move the representation of the respective device from the first position to a second position within the representation of the location, and wherein the second position is different from the first position; and
in response to receiving the set of one or more inputs and in accordance with a determination that a first set of criteria are met:
displaying, via the display component, the representation of the respective device at the second position; and
configuring the respective device in a first manner, such that the respective device is caused to be navigated to a specific location corresponding to the second position when the respective device is caused to be navigated to the location.

9. A computer system that is in communication with a display component and one or more input devices, comprising:
one or more processors; and
memory storing one or more programs configured to be executed by the one or more processors, the one or more programs including instructions for:
after capture of one or more images of a location, displaying, via the display component, a representation of a respective device at a first position within a representation of the location, wherein the representation of the location is generated based on the one or more images;
receiving, via the one or more input devices, a set of one or more inputs, wherein the set of one or more inputs includes an input corresponding to a request to move the representation of the respective device from the first position to a second position within the representation of the location, and wherein the second position is different from the first position; and
in response to receiving the set of one or more inputs and in accordance with a determination that a first set of criteria are met:
displaying, via the display component, the representation of the respective device at the second position; and
configuring the respective device in a first manner, such that the respective device is caused to be navigated to a specific location corresponding to the second position when the respective device is caused to be navigated to the location.
